(19) United States
(12) Patent Application Publication
(10) Pub. No.: US 2023/0259900 A1
(43) Pub. Date: Aug. 17, 2023

(54) METHOD AND SERVER DEVICE FOR IMPLEMENTING NON-FUNGIBLE TOKEN (NFT) ROUND-BY-ROUND ELIMINATION TOURNAMENTS

(71) Applicant: Davis Reed Engle, Overland Park, KS (US)

(72) Inventor: Davis Reed Engle, Overland Park, KS (US)

(21) Appl. No.: 18/110,069

(22) Filed: Feb. 15, 2023

Related U.S. Application Data
(60) Provisional application No. 63/310,360, filed on Feb. 15, 2022.

(51) Int. Cl. G06Q 20/06; G06Q 20/10; G06Q 50/34; A63F 13/792

(52) U.S. Cl. CPC G06Q 20/065; G06Q 20/10; G06Q 50/34; A63F 13/792

(57) ABSTRACT

A method for implementing a non-fungible token round-by-round elimination tournament comprises: listing a plurality of tournaments on a website, each tournament including a plurality of contestants competing against one another and each tournament including a plurality of rounds of events; receiving a request from a first individual to purchase a non-fungible token to become one of the contestants in one of the tournaments; performing the following before one or more round of events: receiving a request from the first individual to sell the non-fungible token; receiving a request from a second individual to buy the non-fungible token; and processing a non-fungible token transaction from the first individual to the second individual.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/310,360; titled “NON-FUNGIBLE TOKEN (NFT) ROUND-BY-ROUND ELIMINATION TOURNAMENTS”; and filed Feb. 15, 2022. The Provisional Application is hereby incorporated by reference, in its entirety, into the current patent application.

### BACKGROUND OF THE INVENTION

Round-by-round elimination tournaments involve a competition between a plurality of contestants who buy a position in the tournament to compete individually against one another. The competition includes a plurality of rounds of events in which the contestants answer questions or participate in other competitive activities. Each round of competition lasts for a period of time ranging from a few minutes or hours to a few days. After each round, some contestants are either eliminated or their chances of winning are diminished. One drawback is that there is no effective way for the contestant to transfer or sell their position in the tournament as the competition progresses.

### SUMMARY OF THE INVENTION

Embodiments of the current invention provide a method and a server device which advance the art of play-to-earn round-by-round elimination tournament gaming by allowing contestants to sell their positions before one or more of the rounds. One embodiment of the method broadly comprises: listing a plurality of tournaments on a website, each tournament including a plurality of contestants competing against one another and each tournament including a plurality of rounds of events; receiving a request from a first individual to purchase a non-fungible token to become one of the contestants in one of the tournaments; performing the following before one or more round of events: receiving a request from the first individual to sell the non-fungible token; receiving a request from a second individual to buy the non-fungible token; and processing a non-fungible token transaction from the first individual to the second individual.

Another embodiment of the method broadly comprises: listing a plurality of tournaments on a website, each tournament including a plurality of contestants competing against one another and each tournament including a plurality of rounds of events; receiving a request from a first individual to purchase a non-fungible token to become one of the contestants in one of the tournaments; recording a score for each contestant at the end of each round in one of the tournaments; eliminating a percentage of the contestants with lower scores at the end of each round in one of the tournaments; performing the following before one or more round of events: receiving a request from the first individual to sell the non-fungible token; receiving a request from a second individual to buy the non-fungible token; and processing a non-fungible token transaction from the first individual to the second individual.

The server device broadly comprises a processing element configured to: provide a website that lists a plurality of tournaments, each tournament including a plurality of contestants competing against one another and each tournament including a plurality of rounds of events; receive a request from a first individual to purchase a non-fungible token to become one of the contestants in one of the tournaments; perform the following before one or more round of events: receive a request from the first individual to sell the non-fungible token; receive a request from a second individual to buy the non-fungible token; and process a non-fungible token transaction from the first individual to the second individual.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is an environmental schematic view of a server device, constructed in accordance with various embodiments of the current invention, for implementing non-fungible token (NFT) round-by-round elimination tournaments, wherein the server device communicates with a plurality of computing nodes through a communication network;

FIG. 2 is a schematic block diagram of various electronic components of the server device;

FIG. 3 is a schematic block diagram of various electronic components of the computing node;

FIG. 4 is a view of a first screen of the computing node implementing software from the server device;

FIG. 5 is a view of a second screen of the computing node implementing software from the server device;

FIG. 6 is a view of a third screen of the computing node implementing software from the server device;

FIG. 7 is a view of a fourth screen of the computing node implementing software from the server device;

FIG. 8 is a view of a fifth screen of the computing node implementing software from the server device;

FIG. 9 is a view of a sixth screen of the computing node implementing software from the server device; and

FIG. 10 is a listing of at least a portion of the steps of a method for implementing NFT round-by-round elimination tournaments.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

A server device 10, constructed in accordance with various embodiments of the current invention, for implementing non-fungible token (NFT) round-by-round elimination tournaments is shown in FIG. 1. The server device 10 communicates with a plurality of computing nodes 12 through a communication network 30 to implement the tournaments. Each tournament includes a plurality of contestants using one of the computing nodes 12 to compete against one another.

The computing nodes 12 may be embodied by workstation computers, desktop computers, laptop computers, palmtop computers, notebook computers, tablets or tablet computers, smartphones, mobile phones, cellular phones, personal digital assistants (PDAs), or the like. Referring to FIG. 2, each computing node 12 broadly comprises a communication element 14, a memory element 16, and a processing element 18.

The communication element 14 generally allows the computing node 12 to communicate with the communication network 30, other computing nodes 12, and the like. The communication element 14 may include signal and/or data transmitting and receiving circuits, such as antennas, amplifiers, filters, mixers, oscillators, digital signal processors (DSPs), and the like. The communication element 14 may establish communication wirelessly by utilizing radio frequency (RF) signals and/or data that comply with communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof. In addition, the communication element 14 may utilize communication standards such as ANT, ANT+, Bluetooth™ low energy (BLE), or the like. Alternatively, or in addition, the communication element 14 may establish communication through connectors or couplers that receive metal conductor wires or cables which are compatible with networking technologies such as ethernet. In certain embodiments, the communication element 14 may also couple with optical fiber cables. The communication element 14 may be in electronic communication with the memory element 16 and the processing element 18.

The memory element 16 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element 16 may be embedded in, or packaged in the same package as, the processing element 18. The memory element 16 may include, or may constitute, a non-transitory “computer-readable medium”. The memory element 16 may store the instructions, code, code statements, code segments, software, firmware, programs, applications, apps, services, daemons, or the like that are executed by the processing element 18. The memory element 16 is in electronic communication with the processing element 18 and may also store data that is received by the processing element 18 or the device in which the processing element 18 is implemented. The processing element 18 may further store data or intermediate results generated during processing, calculations, and/or computations as well as data or final results after processing, calculations, and/or computations. In addition, the memory element 16 may store settings, text data, documents from word processing software, spreadsheet software and other software applications, sampled audio sound files, photograph or other image data, movie data, databases, and the like.

The processing element 18 may comprise one or more processors. The processing element 18 may include electronic hardware components such as microprocessors (single-core or multi-core), microcontrollers, digital signal processors (DSPs), field-programmable gate arrays (FPGAs), analog and/or digital application-specific integrated circuits (ASIC s), intelligence circuitry, or the like, or combinations thereof. The processing element 18 may generally execute, process, or run instructions, code, code segments, code statements, software, firmware, programs, applications, apps, processes, services, daemons, or the like. The processing element 18 may also include hardware components such as registers, finite-state machines, sequential and combinational logic, configurable logic blocks, and other electronic circuits that can perform the functions necessary for the operation of the current invention. In certain embodiments, the processing element 18 may include multiple computational components and functional blocks that are packaged separately but function as a single unit. In some embodiments, the processing element 18 may further include multiprocessor architectures, parallel processor architectures, processor clusters, and the like, which provide high performance computing. The processing element 18 may be in electronic communication with the other electronic components of the computing node 12 through serial or parallel links that include universal busses, address busses, data busses, control lines, and the like. In addition, the processing element 18 may include ADCs to convert analog electronic signals to (streams of) digital data values and/or digital to analog converters (DACs) to convert (streams of) digital data values to analog electronic signals. The processing element 18 may be operable, configured, and/or programmed to perform the functions, operations, processes, methods, and/or algorithms of the computing node 12 by utilizing hardware, software, firmware, or combinations thereof. Other components, such as the communication element 14 and the memory element 16 may be utilized as well.

The communication network 30 generally allows communication between the computing nodes 12 and the server device 10 as well as communication from one computing node 12 to another. The communication network 30 may include the Internet, cellular communication networks, local area networks, metro area networks, wide area networks, cloud networks, telecommunication systems, plain old or public ordinary telephone service (POTS) networks, public switched telephone networks (PSTN), and the like, or combinations thereof. The communication network 30 may be wired, wireless, or combinations thereof and may include components such as modems, gateways, switches, routers, hubs, access points, repeaters, towers, and the like. The computing nodes 12 and the server device 10 may connect to the communication network 30 either through wires, such as electrical cables, utilizing protocols like ethernet, or fiber optic cables, or wirelessly, such as RF communication using wireless standards such as cellular 2G, 3G, 4G, LTE, or 5G, IEEE 802.11 standards such as WiFi, IEEE 802.16 standards such as WiMAX, Bluetooth™, or combinations thereof.

The server device 10 may be embodied by web servers, gaming servers, application servers, database servers, file servers, or the like, or combinations thereof. Furthermore, the server device 10 may include a plurality of servers, virtual servers, or combinations thereof. The server device 10 may be located in a single geolocation or may be geographically separated with various components of the server device 10 being located in a plurality of geolocations. Referring to FIG. 3, the server device 10 broadly comprises a communication element 20, a memory element 22, and a processing element 24. The communication element 20 is similar in structure to the communication element 14 and allows the server device 10 to communicate with the communication network 30. The memory element 22 is similar in structure to the memory element 16 and may include memory storage such as optical drives, hard disk drives, rack-mount drives, blade drives, and the like. The processing element 24 is similar in structure to the processing element 18 and may be operable, configured, and/or programmed to perform the functions, operations, processes, methods, and/or algorithms of the server device 10 by utilizing hardware, software, firmware, or combinations thereof. Other components, such as the communication element 20 and the memory element 22 may be utilized as well.

The server device 10 generally implements or executes a website and acts as host for the tournaments. The server device 10 utilizes or accesses blockchain technology. The server device 10 also includes an NFT marketplace, where individuals and/or contestants can list, buy, sell, and/or trade NFTs and/or other unique digital assets. Alternatively, the server device 10 may be in electronic communication with a third-party NFT marketplace, such as OpenSea, Mintable, Rarible, etc. Examples of the NFT include token standards such as the Ethereum Request for Comment 20 (ERC-20), ERC-721, ERC-1155, and so forth.

In other embodiments, the tournaments may be operated without the use of NFTs. In such embodiments, the server device 10 may include, or be in electronic communication with, a tournament database which includes a listing of each tournament and each contestant in each tournament. The tournament database also includes a listing of transactions of sales of positions or spots in the tournaments.

The server device 10 may implement NFT round-by-round elimination tournaments as follows. The server device 10 implements, executes, or serves the website, which individuals (potential contestants or current contestants) access using one or more computing nodes 12. The computing node 12 may implement or execute a web browser to access the website. Or, the current invention may further include a software application (which is implemented or executed by the computing node 12) that can access the website data. The website may include a plurality of different screens, with each screen providing a different purpose or function. At least a portion of the screens are described herein and shown in the figures as they would be seen on a display of the computing node 12. The screens shown in the figures are merely exemplary.

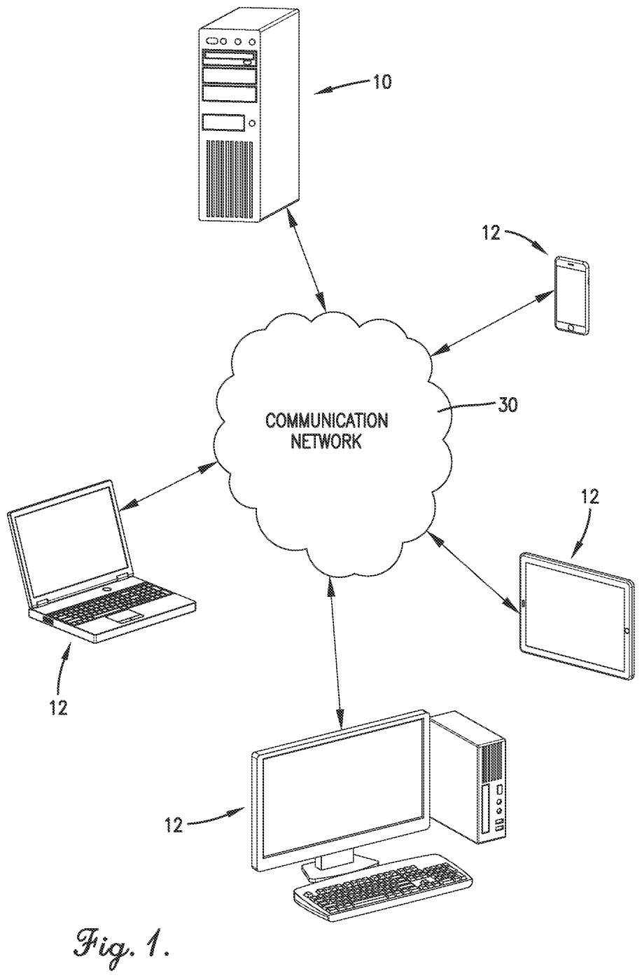

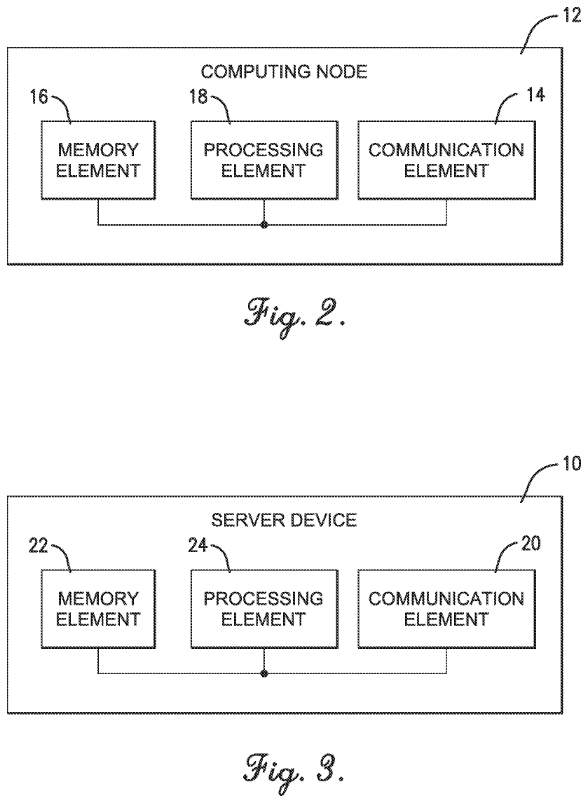

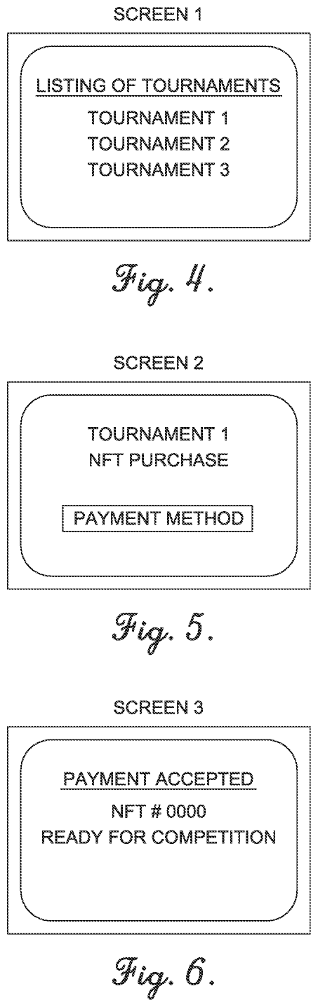

The website may include a first screen, shown in FIG. 4, that includes a listing of the tournaments which are available for an individual to join, or buy a position in as a contestant. The listing of the tournaments typically includes a name of each tournament, a description of each tournament, a number of positions in each tournament, a cost to buy a position in each tournament, and so forth. The individual selects a tournament to join, such as Tournament 1. Upon selection, a second screen, shown in FIG. 5, allows the individual to pay for the NFT to join Tournament 1. The individual may pay using a variety of payment methods. After entering the payment information, a third screen, shown in FIG. 6, informs the now contestant of his NFT number, which is associated with, or identifies, his position in the tournament. In certain embodiments, the individual pays for a spot in the tournament, wherein that spot is not associated with an NFT, but the spot and the associated contestant are tracked in the tournament database. That is, each contestant and their spot or position in the tournament is listed in the tournament database. The contestant receives a receipt or virtual ticket that identifies the tournament and the contestant's position therein.

Each tournament includes a plurality of rounds of events. The events include having the contestants answer questions on a variety of topics, play a game of skill, play a game that combines skill and chance, or the like. Examples of the questions include daily fantasy sports (DFS) questions about the performance of individual athletes or teams in upcoming games, events, seasons, or tournaments (like the men's national college basketball tournament). The questions may also include questions about future events or activities such as stock or fund share prices, weather conditions at a particular place and time, movie and/or music sales, and other projections or predictions. In addition, the questions may include trivia questions on a variety of topics such as history, art, math, science, literature, etc. The games may include sports or games in which two contestants play each other directly such as basketball, golf, tennis, ping pong, chess, and the like. The games may also include video games, such as arcade-style video games, in which two contestants play “head-to-head” or in which individual contestants compete for the highest score. Other games may include card games such as black jack, poker, and so forth.

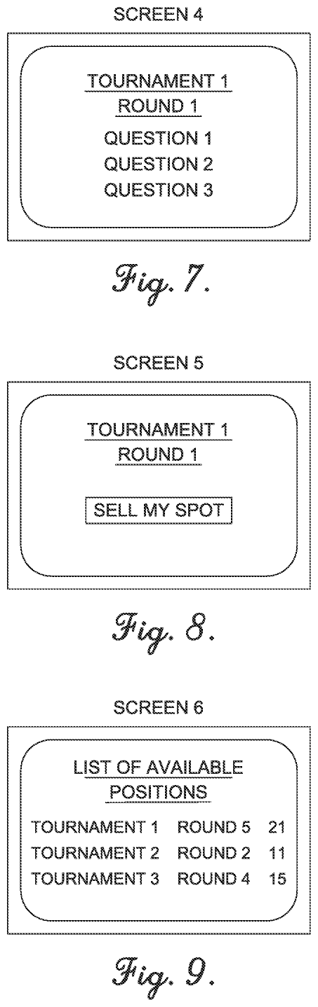

As an example of one round of events, a fourth screen provides each contestant with a plurality of questions, as shown in FIG. 7. A score is assigned to each contestant which varies according to a number of questions that were answered correctly. Generally, a greater number of correct answers results in a higher score, whereas a lesser number of correct answers results in a lower score. In one example, the score may be equivalent to the number of correct answers the contestant has provided.

A percentage of the contestants at the end of each round are eliminated so that they can no longer participate in the particular tournament. This means that each successive round has fewer contestants than the previous round, which in turn increases the value of the NFT for those contestants who remain in the later rounds. In head-to-head type competitive events, such as sports games or video games, contestants who lose a head-to-head match are eliminated. In group-type competitive events, such as answering fantasy sports or trivia questions, contestants are eliminated according to the scores at the end of a round. For example, the contestants with the bottom twenty percent (20%) of the scores are eliminated at the end of each round. The value of the percentage may be constant or may vary from round to round. If two or more players are tied at the cutoff percentage score, then each contestant is presented with one or more new, tiebreaker questions which have a specific value or numerical choice answer. Contestants who answer the questions incorrectly are eliminated until the correct percentage of contestants remain to continue to the next round. To continue the example, suppose at the beginning of a round, there are one hundred (100) contestants. At the end of the round, twenty (20) should be eliminated, but there are five (5) contestants tied at the cutoff score and only two (2) can proceed. The five (5) contestants are presented with tiebreaker questions until three (3) contestants are eliminated and two (2) contestants remain.

The competition continues in this fashion with a percentage of the contestants being eliminated at the end of each round until a designated number of contestants remain. The grand prize may be structured for a single winner or for multiple winners. Examples of the grand prize include a meet-and-greet experience with a famous athlete or celebrity, a luxury vacation, an expensive car, a house, cryptocurrency or cash, tickets to a concert or sporting event, jewelry, rare NFTs, rare goods (shoes, clothing, electronics, etc.), and the like. Each winning contestant can turn in their NFT to claim their share of the grand prize, or they can sell their NFT to someone else to claim the share of the grand prize. Those contestants who did not win can place their non-winning NFT for sale on the marketplace. Anyone who collects a certain number and/or type of these non-winning NFTs (there will be multiple levels of rarity per tournament) can turn them in to the hosting company for free entrance to future tournaments and other prizes.

In other embodiments, the contestant may turn in their receipt or virtual ticket which may serve as proof of purchase of the tournament spot or position.

Before each round, including the first round, each contestant has the opportunity to sell their NFT to someone else to take the contestant's position in the tournament, as shown in the fifth screen of FIG. 8. Listing the NFT for sale places the contestant's position in the tournament on the marketplace of the website, as shown in the sixth screen of FIG. 9. The sixth screen may display a listing of available positions in each tournament that is active. The sixth screen may further display a number of the round that is occurring for the tournament along with a number of positions that are available. If a contestant is determining whether to sell their position, one thing to keep in mind is that the NFT or position of the contestant who continues to successive rounds is more valuable since there are fewer contestants in each successive round. Someone looking to enter one of the tournaments makes a purchase offer or request on one of the NFTs and the accompanying tournament position. If the contestant looking to sell accepts the offer, then a payment transaction is made from the buyer to the seller. The purchaser then becomes the contestant and takes the previous contestant's position in the current round of the tournament.

All of the transactions that occur, including the buying and selling of NFTs, are implemented as the user or contestant at the computing node 12 connecting to a blockchain.

In other embodiments, the contestant may offer their receipt or virtual ticket indicating their tournament spot for sale. If a second individual buys the receipt or virtual ticket, the tournament database records a listing of the transaction.

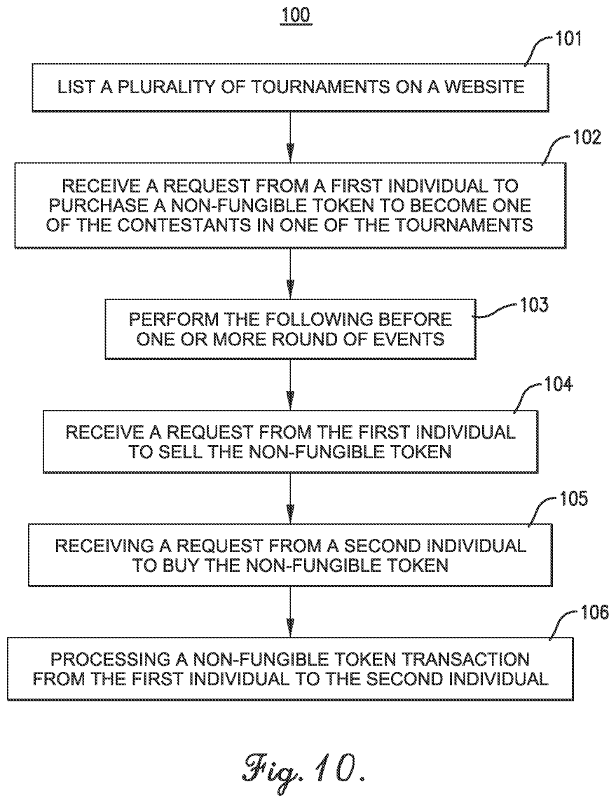

FIG. 10 depicts a listing of at least a portion of the steps of an exemplary computer-implemented method 100 for implementing NFT round-by-round elimination tournaments. The steps may be performed in the order shown in FIG. 10, or they may be performed in a different order. Furthermore, some steps may be performed concurrently as opposed to sequentially. In addition, some steps may be optional or may not be performed. The steps may be performed by the processing element 24 of the server device 10 via hardware, software, firmware, or combinations thereof. Also, the steps may be implemented as instructions, code, code segments, code statements, a program, an application, an app, a process, a service, a daemon, or the like, and may be stored on a computer-readable storage medium, such as the memory element 22.

Referring to step 101, a plurality of tournaments is listed on a website. The website is provided, executed, or implemented on the server device 10, which utilizes or accesses blockchain technology. The server device 10 also includes an NFT marketplace, where individuals and/or contestants can list, buy, sell, and/or trade NFTs and/or other unique digital assets. Alternatively, the server device 10 may be in electronic communication with a third-party NFT marketplace, such as OpenSea, Mintable, Rarible, etc. Examples of the NFT include token standards such as the ERC-20, ERC-721, ERC-1155, and so forth.

In other embodiments, the tournaments may be operated without the use of NFTs. In such embodiments, the server device 10 may include, or be in electronic communication with, a tournament database which includes a listing of each tournament and each contestant in each tournament. The tournament database also includes a listing of transactions of sales of positions or spots in the tournaments.

The server device 10 implements, executes, or serves the website, which individuals (potential contestants or current contestants) access using one or more computing nodes 12. The computing node 12 may implement or execute a web browser to access the website. Or, the current invention may further include a software application (which is implemented or executed by the computing node 12) that can access the website data. The website may include a plurality of different screens, with each screen providing a different purpose or function. At least a portion of the screens are described herein and shown in the figures as they would be seen on a display of the computing node 12. The screens shown in the figures are merely exemplary.

The website may include a first screen, shown in FIG. 4, that includes a listing of the tournaments which are available for an individual to join, or buy a position in as a contestant. The listing of the tournaments typically includes a name of each tournament, a description of each tournament, a number of positions in each tournament, a cost to buy a position in each tournament, and so forth.

Referring to step 102, a request from a first individual to purchase a non-fungible token to become one of the contestants in one of the tournaments is received. While viewing the first screen, shown in FIG. 4, the individual selects a tournament to join, such as Tournament 1. Upon selection, a second screen, shown in FIG. 5, allows the individual to pay for the NFT to join Tournament 1. The individual may pay using a variety of payment methods. After entering the payment information, a third screen, shown in FIG. 6, informs the now contestant of his NFT number.

In certain embodiments, the individual pays for a spot in the tournament, wherein that spot is not associated with an NFT, but the spot and the associated contestant are tracked in the tournament database. That is, each contestant and their spot or position in the tournament is listed in the tournament database. The contestant receives a receipt or virtual ticket that identifies the tournament and the contestant's position therein.

Each tournament includes a plurality of rounds of events. The events include having the contestants answer questions on a variety of topics, play a game of skill, play a game that combines skill and chance, or the like. Examples of the questions include daily fantasy sports (DFS) questions about the performance of individual athletes or teams in upcoming games, events, seasons, or tournaments (like the men's national college basketball tournament). The questions may also include questions about future events or activities such as stock or fund share prices, weather conditions at a particular place and time, movie and/or music sales, and other projections or predictions. In addition, the questions may include trivia questions on a variety of topics such as history, art, math, science, literature, etc. The games may include sports or games in which two contestants play each other directly such as basketball, golf, tennis, ping pong, chess, and the like. The games may also include video games, such as arcade-style video games, in which two contestants play “head-to-head” or in which individual contestants compete for the highest score. Other games may include card games such as black jack, poker, and so forth.

As an example of one round of events, a fourth screen provides each contestant with a plurality of questions, as shown in FIG. 7. A score is assigned to each contestant which varies according to a number of questions that were answered correctly. Generally, a greater number of correct answers results in a higher score, whereas a lesser number of correct answers results in a lower score. In one example, the score may be equivalent to the number of correct answers the contestant has provided.

A percentage of the contestants at the end of each round are eliminated so that they can no longer participate in the particular tournament. This means that each successive round has fewer contestants than the previous round, which in turn increases the value of the NFT for those contestants who remain in the later rounds. In head-to-head type competitive events, such as sports games or video games, contestants who lose a head-to-head match are eliminated. In group-type competitive events, such as answering fantasy sports or trivia questions, contestants are eliminated according to the scores at the end of a round. For example, the contestants with the bottom twenty percent (20%) of the scores are eliminated at the end of each round. The value of the percentage may be constant or may vary from round to round. If two or more players are tied at the cutoff percentage score, then each contestant is presented with one or more new, tiebreaker questions which have a specific value or numerical choice answer. Contestants who answer the questions incorrectly are eliminated until the correct percentage of contestants remain to continue to the next round. To continue the example, suppose at the beginning of a round, there are one hundred (100) contestants. At the end of the round, twenty (20) should be eliminated, but there are five (5) contestants tied at the cutoff score and only two (2) can proceed. The five (5) contestants are presented with tiebreaker questions until three (3) contestants are eliminated and two (2) contestants remain.

The competition continues in this fashion with a percentage of the contestants being eliminated at the end of each round until a designated number of contestants remain. The grand prize may be structured for a single winner or for multiple winners. Examples of the grand prize include a meet-and-greet experience with a famous athlete or celebrity, a luxury vacation, an expensive car, a house, cryptocurrency or cash, tickets to a concert or sporting event, jewelry, rare NFTs, rare goods (shoes, clothing, electronics, etc.), and the like. Each winning contestant can turn in their NFT to claim their share of the grand prize, or they can sell their NFT to someone else to claim the share of the grand prize. Those contestants who did not win can place their non-winning NFT for sale on the marketplace. Anyone who collects a certain number and/or type of these non-winning NFTs (there will be multiple levels of rarity per tournament) can turn them in to the hosting company for free entrance to future tournaments and other prizes.

In other embodiments, the contestant may turn in their receipt or virtual ticket which may serve as proof of purchase of the tournament spot or position.

Referring to steps 103, 104, 105, and 106, before each round, including the first round, each contestant has the opportunity to request to sell their NFT to someone else to take the contestant's position in the tournament, as shown in the fifth screen of FIG. 8. Listing the NFT for sale places the contestant's position in the tournament on the marketplace of the website, as shown in the sixth screen of FIG. 9. The sixth screen may display a listing of available positions in each tournament that is active. The sixth screen may further display a number of the round that is occurring for the tournament along with a number of positions that are available. Someone looking to enter one of the tournaments makes a request to purchase one of the NFTs and the accompanying tournament position. If the contestant looking to sell accepts the offer, then a payment transaction is made from the buyer to the seller. The purchaser then becomes the contestant and takes the previous contestant's position in the current round of the tournament.

In other embodiments, the contestant may offer their receipt or virtual ticket indicating their tournament spot for sale. If a second individual buys the receipt or virtual ticket, the tournament database records a listing of the transaction.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method for implementing a non-fungible token round-by-round elimination tournament, the method comprising:
listing a plurality of tournaments on a website, each tournament including a plurality of contestants competing against one another and each tournament including a plurality of rounds of events;
receiving a request from a first individual to purchase a non-fungible token to become one of the contestants in one of the tournaments;
performing the following before one or more round of events:
receiving a request from the first individual to sell the non-fungible token;
receiving a request from a second individual to buy the non-fungible token; and
processing a non-fungible token transaction from the first individual to the second individual.

2. The method of claim 1, further comprising recording a score for each contestant at the end of each round in one of the tournaments.

3. The method of claim 1, further comprising eliminating a percentage of the contestants at the end of each round in one of the tournaments.

4. The method of claim 3, wherein eliminating the percentage of the contestants includes eliminating contestants with lower scores.

5. The method of claim 3, wherein eliminating the percentage of the contestants includes providing tiebreaker events to two or more contestants who have an equivalent score at the end of one of the rounds and eliminating one or more contestants who lose the tiebreaker events.

6. The method of claim 1, further comprising presenting a plurality of daily fantasy sports questions to the contestants during each round of events.

7. The method of claim 6, further comprising receiving answers to the daily fantasy sports questions and assigning a score to each contestant, the score varying according to a number of correct answers.

8. The method of claim 1, wherein processing the non-fungible token transaction from the first individual to the second individual includes processing payment from the second individual to the first individual.

9. The method of claim 1, wherein each contestant joins the tournament as a computing node connecting to a blockchain.

10. A method for implementing a non-fungible token round-by-round elimination tournament, the method comprising:
listing a plurality of tournaments on a website, each tournament including a plurality of contestants competing against one another and each tournament including a plurality of rounds of events;
receiving a request from a first individual to purchase a non-fungible token to become one of the contestants in one of the tournaments;
recording a score for each contestant at the end of each round in one of the tournaments;
eliminating a percentage of the contestants with lower scores at the end of each round in one of the tournaments;
performing the following before one or more round of events:
receiving a request from the first individual to sell the non-fungible token;
receiving a request from a second individual to buy the non-fungible token; and
processing a non-fungible token transaction from the first individual to the second individual.

11. The method of claim 10, wherein eliminating the percentage of the contestants includes providing tiebreaker events to two or more contestants who have an equivalent score at the end of one of the rounds and eliminating one or more contestants who lose the tiebreaker events.

12. The method of claim 10, further comprising presenting a plurality of daily fantasy sports questions to the contestants during each round of events.

13. The method of claim 12, further comprising receiving answers to the daily fantasy sports questions and assigning a score to each contestant, the score varying according to a number of correct answers.

14. The method of claim 10, wherein processing the non-fungible token transaction from the first individual to the second individual includes processing payment from the second individual to the first individual.

15. The method of claim 10, wherein each contestant joins the tournament as a computing node connecting to a blockchain.

16. A server device for implementing a non-fungible token round-by-round elimination tournament, the server device comprising:
a processing element configured to:
provide a website that lists a plurality of tournaments, each tournament including a plurality of contestants competing against one another and each tournament including a plurality of rounds of events;
receive a request from a first individual to purchase a non-fungible token to become one of the contestants in one of the tournaments;
perform the following before one or more round of events:
receive a request from the first individual to sell the non-fungible token;
receive a request from a second individual to buy the non-fungible token; and
process a non-fungible token transaction from the first individual to the second individual.

17. The server device of claim 16, wherein the processing element is further configured to:
record a score for each contestant at the end of each round in one of the tournaments;
eliminate a percentage of the contestants with lower scores at the end of each round in one of the tournaments;
provide tiebreaker events to two or more contestants who have an equivalent score at the end of one of the rounds; and
eliminate one or more contestants who lose the tiebreaker events.

18. The server device of claim 16, wherein the processing element is further configured to:
present a plurality of daily fantasy sports questions to the contestants during each round of events; and
receive answers to the daily fantasy sports questions and assigning a score to each contestant, the score varying according to a number of correct answers.

19. The server device of claim 16, wherein the processing element is further configured to process payment from the second individual to the first individual when processing the non-fungible token transaction from the first individual to the second individual.

20. The server device of claim 16, wherein each contestant joins the tournament as a computing node connecting to a blockchain.
